(19) United States
(12) Patent Application Publication
(10) Pub. No.: US 2020/0074147 A1
(43) Pub. Date: Mar. 5, 2020

(54) INFORMATION PROCESSING DEVICE AND INFORMATION PROCESSING METHOD

(71) Applicant: FANUC CORPORATION, Yamanashi (JP)

(72) Inventor: Tatsuhiro Yamazaki, Yamanashi-ken (JP)

(73) Assignee: FANUC CORPORATION, Yamanashi (JP)

(21) Appl. No.: 16/550,704

(22) Filed: Aug. 26, 2019

(30) Foreign Application Priority Data
Aug. 31, 2018 (JP) 2018-163703

(51) Int. Cl. G06K 9/00; B25J 9/10

(52) U.S. Cl. CPC G06K 9/00201; B25J 9/1035

(57) ABSTRACT

An information processing device includes: a three-dimensional sensor configured to detect a three-dimensional shape of a detection target supported on a supporting member; a threshold setting unit configured to set a height threshold of a height from a supporting surface of the supporting member on which the detection target is placed; and a binarization processing unit configured to apply binarization processing based on the height threshold to three-dimensional information representing the three-dimensional shape to thereby generate two-dimensional information representing a two-dimensional shape of the detection target.

### CROSS-REFERENCE TO RELATED APPLICATION

This application is based upon and claims the benefit of priority from Japanese Patent Application No. 2018-163703 filed on Aug. 31, 2018, the contents of which are incorporated herein by reference.

### BACKGROUND OF THE INVENTION

### Field of the Invention

The present invention relates to an information processing device and an information processing method.

### Description of the Related Art

In the field of robot technologies, when a robot grips a component (a detection target) with a hand, inclinations of fingers or the like may be compensated based on a two-dimensional image of the component captured by a camera (see Japanese Laid-Open Patent Publication No. 2018-103292).

### SUMMARY OF THE INVENTION

However, if the illuminance is not sufficient or the component and the background have the same color, then the component and background in the image captured by the camera may be undistinguishable, for example, in which case the shape of the component will not be extracted accurately. Then, the processing of compensating the inclinations of the fingers or the like for gripping the component cannot be performed appropriately, and as a result the robot will fail to grip the component.

An object of the present invention is to provide an information processing device and an information processing method for generating information representing the shape of a detection target to enable a robot to grip the detection target properly.

According to a first aspect of the present invention, an information processing device includes: a three-dimensional sensor configured to detect a three-dimensional shape of a detection target supported on a supporting member; a threshold setting unit configured to set a height threshold of a height from a supporting surface of the supporting member on which the detection target is placed; and a binarization processing unit configured to apply binarization processing based on the height threshold to three-dimensional information representing the three-dimensional shape to thereby generate two-dimensional information representing a two-dimensional shape of the detection target.

According to a second aspect of the present invention, an information processing method performed by an information processing device includes: a three-dimensional shape detecting step of detecting a three-dimensional shape of a detection target supported on a supporting member; a threshold setting step of setting a height threshold of a height from a supporting surface of the supporting member on which the detection target is placed; and a binarization step of applying binarization processing based on the height threshold to three-dimensional information representing the three-dimensional shape to thereby generate two-dimensional information representing a two-dimensional shape of the detection target.

According to the present invention, it is possible to generate information representing the shape of the detection target in order to enable a robot to grip the detection target properly.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing functional blocks of an information processing device according to an embodiment;

FIG. 2 is a flowchart showing an example of processing conducted by the information processing device of the embodiment;

FIG. 3A is a diagram showing an example of a detection target for explaining the processing by the information processing device of the embodiment, and FIG. 3B is a diagram showing another example of the detection target for explaining the processing by the information processing device of the embodiment; FIG. 4A is a diagram used to explain an example of the processing by the information processing device of the embodiment, and FIG. 4B is a diagram used to explain another example of the processing by the information processing device of the embodiment;

FIG. 5A is a diagram illustrating an image generated by detecting a detection target by a two-dimensional sensor, FIG. 5B is a diagram illustrating an image generated by detecting the detection target by a three-dimensional sensor without binarization, and FIG. 5C is a diagram illustrating an image based on two-dimensional information generated by imaging the detection target with the information processing device of this embodiment; and

FIG. 6A is a diagram illustrating an image generated by detecting a detection target by a two-dimensional sensor, FIG. 6B is a diagram illustrating an image generated by detecting the detection target by a three-dimensional sensor without binarization, and FIG. 6C is a diagram illustrating an image based on two-dimensional information generated by imaging the detection target with the information processing device of this embodiment.

### DESCRIPTION OF THE PREFERRED EMBODIMENTS

The information processing device and information processing method according to the present invention will now be described in detail in conjunction with preferred embodiments while referring to the accompanying drawings.

### Embodiment

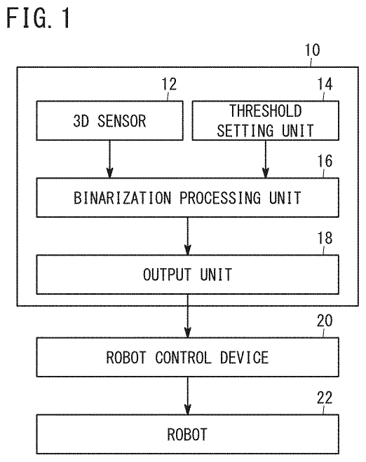

FIG. 1 is a diagram showing functional blocks of an information processing device 10 according to this embodiment. The information processing device 10 includes a three-dimensional sensor (3D sensor) 12, a threshold setting unit 14, a binarization processing unit 16, and an output unit 18.

The three-dimensional sensor 12 includes an imaging device such as a CCD or CMOS, for example. The three-dimensional sensor 12 may be configured to detect the three-dimensional shape of the target of imaging by using ToF (Time-of-Flight), or to detect the three-dimensional shape of the target of imaging based on the parallax between two imaging devices. The three-dimensional sensor 12 generates a three-dimensional image that represents the three-dimensional shape (also referred to as three-dimensional information).

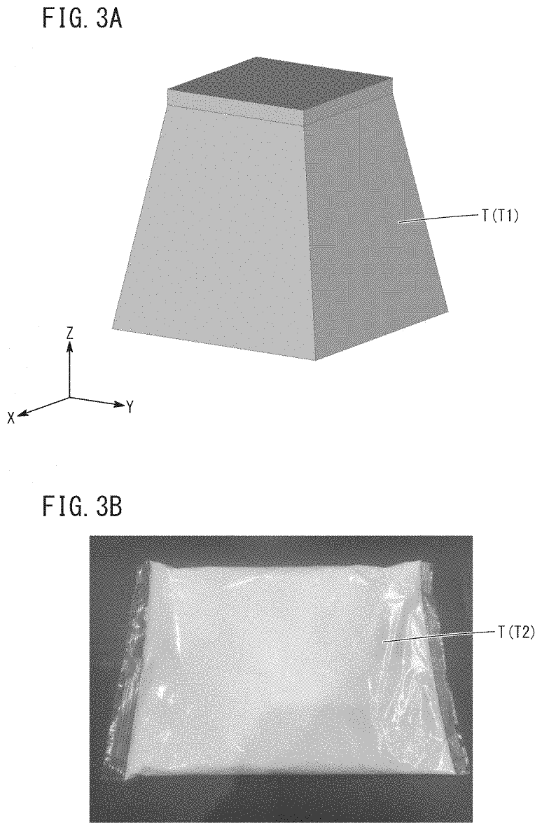

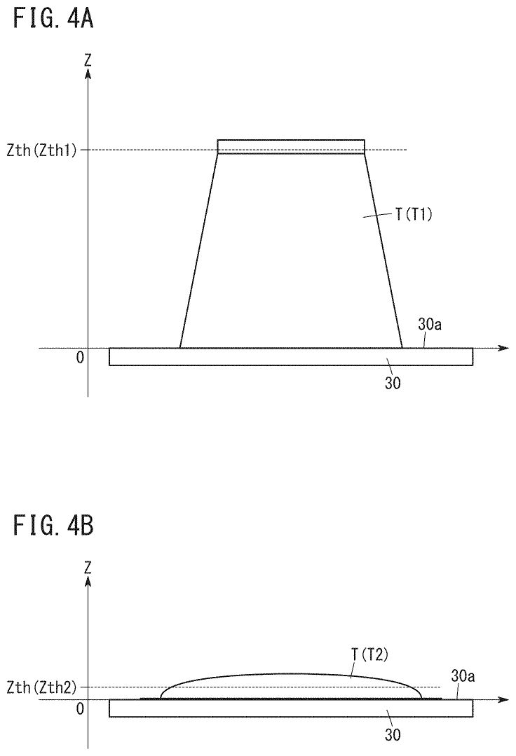

Now, if a supporting surface 30a of a supporting member 30 for supporting a detection target T is defined as an XY plane (see FIGS. 3A, 4A, 4B), the three-dimensional sensor 12 is disposed across the detection target T from the supporting member 30 (i.e., above the detection target) in a Z direction perpendicular to the XY plane. When the direction in which gravity acts is defined as a downward direction and the direction opposite to the downward direction is defined as an upward direction, then the supporting member 30 and the detection target T are located on the downward direction side seen from the three-dimensional sensor 12.

The three-dimensional information includes XY coordinate positions (also referred to as two-dimensional coordinate positions) in the XY plane being the supporting surface 30a of the supporting member 30. When a distance from the supporting surface 30a in the upward direction which is perpendicular to the supporting surface 30a is denoted as a height Z, the three-dimensional information further includes information indicating the height Z of the detection target T from the supporting surface 30a at each XY coordinate position (also referred to as height information).

The threshold setting unit 14 sets a threshold of the height Z from the supporting surface 30a of the supporting member 30 on which the detection target T is placed (also referred to as a height threshold Zth). The threshold setting unit 14 may be configured to set a value entered by a user as the height threshold Zth, or to set the height threshold Zth based on information indicating the kind of the detection target T entered by the user.

The binarization processing unit 16 applies binarization processing to the three-dimensional information based on the height threshold Zth. That is, the binarization processing unit 16 binarizes the height information contained in the three-dimensional information on the basis of the height threshold Zth. In the XY plane, the binarization processing unit 16 of this embodiment assigns 1 to XY coordinate positions where the height of the detection target T is equal to or more than the height threshold Zth and assigns 0 to XY coordinate positions where the height is less than the height threshold Zth. The binarized three-dimensional information can be represented as a two-dimensional image. Hereinafter, the two-dimensional image obtained by the binarization of the three-dimensional information, i.e., the values of 0 or 1 assigned to the individual XY coordinate positions, is also referred to as two-dimensional information. In this embodiment, it is assumed that the values 1 and 0 assigned to each XY coordinate position are values corresponding to white and black in the image, respectively. The output unit 18 outputs the two-dimensional information to a robot control device 20. The robot control device 20 is a device configured to control a robot 22, where the robot 22 is, for example, a multi-articulated arm robot having a hand attached to a distal end thereof, the hand having a plurality of fingers for gripping the detection target T. The robot control device 20 compensates, on the basis of the two-dimensional information, the axis directions of the arm, hand, and fingers of the robot 22, intervals between fingers, and so on. The robot control device 20 controls the robot 22 based on the compensated contents to thereby cause the robot 22 to grip the detection target T.

The information processing device 10 may be composed of a processor such as a CPU (Central Processing Unit) or MPU (Micro Processing Unit) etc., memory such as ROM (Read Only Memory) and RAM (Random Access Memory) etc., the three-dimensional sensor, various interface circuits, and so on. The processor executes processing using programs and various information stored in the memory to thereby realize the function of the binarization processing unit 16. The function of the threshold setting unit 14 can be realized by the processor executing processing using programs and various information stored in the memory in accordance with the kind or the like of the detection target T entered through user interface circuitry. The function of the output unit 18 can be realized by an input/output interface circuit or a communication interface circuit.

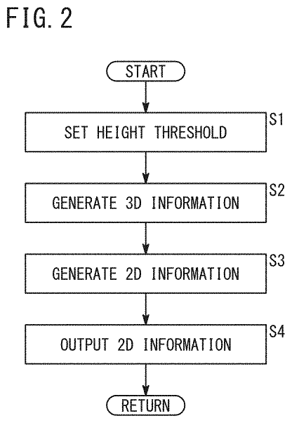

FIG. 2 is a flowchart showing an example of the processing of the information processing device 10 of this embodiment. At step S1, the threshold setting unit 14 sets the height threshold Zth. Next, at step S2, the three-dimensional sensor 12 detects a three-dimensional shape of the detection target T. Three-dimensional information representing the three-dimensional shape is thus generated. At step S3, the binarization processing unit 16 generates two-dimensional information by binarizing the height information in the three-dimensional information on the basis of the height threshold Zth set at step S1. At step S4, the output unit 18 outputs the two-dimensional information generated by the binarization processing unit 16 at step S3 to the robot control device 20.

FIG. 3A is a diagram showing an example of the detection target T (hereinafter also referred to as T1) for explaining the processing by the information processing device 10 of this embodiment. FIG. 3B is a diagram showing another example of the detection target T (hereinafter also referred to as T2) for explaining the processing by the information processing device 10 of this embodiment. The detection target T2 shown in FIG. 3B is, for example, a package in which some fluid (e.g., soup), powder (e.g., wheat flour) or the like is packed.

FIG. 4A is a diagram used to explain an example of the processing by the information processing device 10 of this embodiment. FIG. 4B is a diagram used to explain another example of the processing by the information processing device 10 of this embodiment. FIG. 4A shows the detection target T1 and the supporting member 30 in a plan view from a direction perpendicular to the Z-axis. FIG. 4B shows the detection target T2 and the supporting member 30 in a plan view from the direction perpendicular to the Z-axis. In order to facilitate understanding, the height Z of the supporting surface 30a is assumed to be 0.

The detection target T1 shown in FIG. 4A is relatively tall. Accordingly, the position at which the robot 22 grips the detection target T1 is a high position. Accordingly, the threshold setting unit 14 sets a relatively high position as the height threshold Zth (hereinafter also referred to as Zth1). The set height threshold Zth1 is a height position that is within a given distance of the position at which the robot 22 grips the detection target T1. The binarization processing unit 16 assigns 1 to a portion of the detection target T1 where the height Z is Zth1 or higher, and assigns 0 to a portion thereof where the height Z is less than Zth1.

The detection target T2 shown in FIG. 4B has a large area extending along the supporting surface 30a and its height Z is low. Accordingly, the position at which the robot 22 grips the detection target T2 is a low position. Consequently, the threshold setting unit 14 sets a low position as the height threshold Zth (hereinafter also referred to as Zth2). As mentioned above, the set height threshold Zth2 is a height position that is within a given distance of the position at which the robot 22 grips the detection target T2. The binarization processing unit 16 assigns 1 to a portion of the detection target T2 where the height Z is Zth2 or higher, and assigns 0 to a portion thereof where the height Z is less than Zth2.

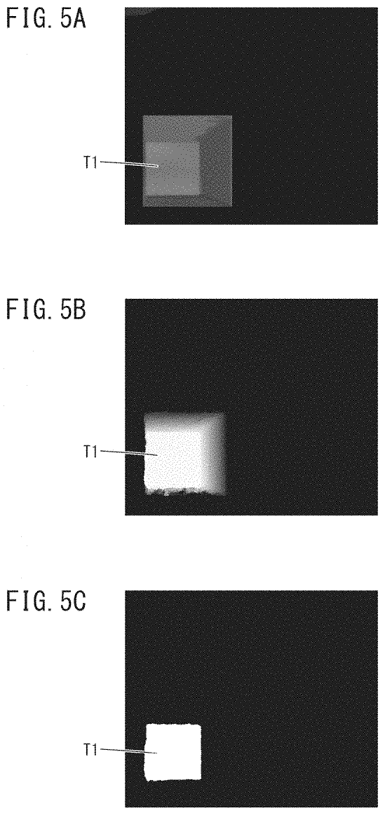

Now, referring to FIGS. 5A to 5C, effects of the processing by the information processing device 10 of this embodiment will be described in comparison with comparative examples in a case where the detection target shown in FIG. 3A is detected.

FIG. 5A is a diagram illustrating an image generated by detecting the detection target T1 shown in FIG. 3A using a two-dimensional sensor. As shown in FIG. 5A, if the illuminance of the lighting is insufficient or the lighting angle is not desirable, the boundary of a portion of the detection target T1 to be gripped by the robot is unclear and the shape of the portion thereof to be gripped cannot be recognized correctly. Consequently, in the case of using this image, the robot control device 20 may be unable to obtain proper information about the two-dimensional shape of the detection target T1 that is necessary for compensation processing or the like for the axes of the fingers (hereinafter also referred to as “the compensation processing or the like”) in order to enable the robot 22 to grip the detection target T1.

FIG. 5B is a diagram illustrating an image generated by detecting the detection target T1 shown in FIG. 3A using a three-dimensional sensor without performing the binarization processing described above. As shown in FIG. 5B, depending on the position where the detection target T1 is placed on the supporting surface 30a, not only the top surface but also the side surfaces of the detection target T1 may be detected. Then, the unnecessary side surface portions (side portions) are undesirably included in the two-dimensional shape necessary for the robot 22 to grip the detection target T1. As a result, the boundary of the shape of a portion of the detection target T1 to be gripped becomes unclear and the shape of the portion thereof to be gripped cannot be recognized correctly. Consequently, the robot control device 20 fails to properly perform the compensation processing or the like in order to facilitate gripping of the detection target T1 with the robot 22.

FIG. 5C is a diagram illustrating an image based on the two-dimensional information that the information processing device 10 of this embodiment generates by imaging the detection target T1 shown in FIG. 3A. As shown in FIG. 5C, the binarization processing suppresses undesirable inclusion of the side portions, in which the height Z is lower than the height threshold Zth1, in the two-dimensional shape required to enable the robot 22 to grip the detection target T1. The robot control device 20 can then perform the compensation processing or the like properly, and the robot 22 can grip the detection target T1 properly.

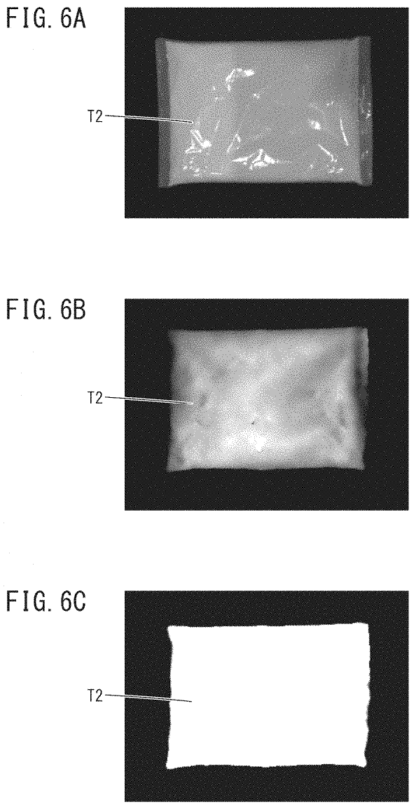

FIG. 6A is a diagram illustrating an image generated by detecting the detection target T2 shown in FIG. 3B using a two-dimensional sensor. As shown in FIG. 6A, if the illuminance of the lighting is insufficient, for example, the boundary of the detection target T2 may be unclear. Then, the robot control device 20 may be unable to obtain proper information about the two-dimensional shape of the detection target T2 that is necessary for the compensation processing or the like for enabling the robot 22 to grip the detection target T2.

FIG. 6B is a diagram illustrating an image generated by detecting the detection target T2 shown in FIG. 3B using a three-dimensional sensor without performing the binarization processing. As shown in FIG. 6B, the boundary of the detection target T2 may be unclear, for example because the height of the edge portion of the detection target T2 is close to the supporting surface 30a. Then, the robot control device 20 may be unable to obtain proper information about the two-dimensional shape of the detection target T2 that is necessary for the compensation processing or the like for enabling the robot 22 to grip the detection target T2.

FIG. 6C is a diagram illustrating an image based on two-dimensional information that the information processing device 10 of this embodiment generates by imaging the detection target T2 shown in FIG. 3B. The binarization processing using the height threshold Zth2 shown in FIG. 4B makes it possible to correctly recognize the contour of the detection target T2 as shown in FIG. 6C. By using the two-dimensional information representing such a clear contour, the robot control device 20 can perform the compensation processing or the like properly and the robot 22 can grip the detection target T2 properly.

As described so far, according to the information processing device 10 of this embodiment, it is possible to provide the robot control device 20 with two-dimensional information representing the two-dimensional shape required to enable the robot 22 to properly grip the detection target T. This allows the robot control device 20 to perform the compensation processing or the like based on the two-dimensional information and to control the gripping operation of the robot 22 properly.

[Technical Ideas Obtained from Embodiment]

Technical ideas that can be gripped from the embodiment above will be recited below.

### <First Technical Idea>

The information processing device (10) includes: a three-dimensional sensor (12) configured to detect a three-dimensional shape of a detection target (T, T1, T2) supported on a supporting member (30); a threshold setting unit (14) configured to set a height threshold (Zth, Zth1, Zth2) of a height from a supporting surface (30a) of the supporting member (30) on which the detection target (T, T1, T2) is placed; and a binarization processing unit (16) configured to apply binarization processing based on the height threshold (Zth, Zth1, Zth2) to three-dimensional information representing the three-dimensional shape to thereby generate two-dimensional information representing a two-dimensional shape of the detection target (T, T1, T2).

It is thus possible to generate information representing the shape of the detection target (T, T1, T2) for enabling the robot (22) to properly grip the detection target (T, T1, T2).

The information processing device (10) may further include an output unit (18) configured to output the two-dimensional information to a robot control device (20) configured to control operation of a hand of a robot (22) that grips the detection target (T, T1, T2). The robot control device (20) can thus enable the robot (22) to grip the detection target (T, T1, T2).

### <Second Technical Idea>

An information processing method performed by an information processing device (10) includes: a three-dimensional shape detecting step of detecting a three-dimensional shape of a detection target (T, T1, T2) supported on a supporting member (30); a threshold setting step of setting a height threshold (Zth, Zth1, Zth2) of a height from a supporting surface (30a) of the supporting member (30) on which the detection target (T, T1, T2) is placed; and a binarization step of applying binarization processing based on the height threshold (Zth, Zth1, Zth2) to three-dimensional information representing the three-dimensional shape to thereby generate two-dimensional information representing a two-dimensional shape of the detection target (T, T1, T2).

It is thus possible to generate information representing the shape of the detection target (T, T1, T2) for enabling the robot (22) to properly grip the detection target (T, T1, T2).

The information processing method may further include an output step of outputting the two-dimensional information to a robot control device (20) configured to control operation of a hand of a robot (22) that grips the detection target (T, T1, T2). The robot control device (20) can thus enable the robot (22) to grip the detection target (T, T1, T2).

The present invention is not particularly limited to the embodiment described above, and various modifications are possible without departing from the essence and gist of the present invention.

What is claimed is:

1. An information processing device comprising:
a three-dimensional sensor configured to detect a three-dimensional shape of a detection target supported on a supporting member;
a threshold setting unit configured to set a height threshold of a height from a supporting surface of the supporting member on which the detection target is placed; and
a binarization processing unit configured to apply binarization processing based on the height threshold to three-dimensional information representing the three-dimensional shape to thereby generate two-dimensional information representing a two-dimensional shape of the detection target.

2. The information processing device according to claim 1, further comprising an output unit configured to output the two-dimensional information to a robot control device configured to control operation of a hand of a robot that grips the detection target.

3. An information processing method performed by an information processing device, comprising:
a three-dimensional shape detecting step of detecting a three-dimensional shape of a detection target supported on a supporting member;
a threshold setting step of setting a height threshold of a height from a supporting surface of the supporting member on which the detection target is placed; and
a binarization step of applying binarization processing based on the height threshold to three-dimensional information representing the three-dimensional shape to thereby generate two-dimensional information representing a two-dimensional shape of the detection target.

4. The information processing method according to claim 3, further comprising an output step of outputting the two-dimensional information to a robot control device configured to control operation of a hand of a robot that grips the detection target.
